(19) United States
(12) Patent Application Publication
(10) Pub. No.: US 2020/0013347 A1
(43) Pub. Date: Jan. 9, 2020

(54) REFLECTIVE DISPLAYS WITH ADDED COLOURS AND METHODS FOR MAKING THE SAME

(71) Applicant: Displaydata Limited, Worcestershire (GB)

(72) Inventors: Guy Bryan-Brown, Worcester (GB); Christopher Picken, Gloucestershire (GB)

(21) Appl. No.: 16/503,043

(22) Filed: Jul. 3, 2019

Related U.S. Application Data
(60) Provisional application No. 62/694,133, filed on Jul. 5, 2018.

(51) Int. Cl. G09G 3/34; G02F 1/167

(52) U.S. Cl. CPC G09G 3/344; G02F 1/167

(57) ABSTRACT

The present invention relates to devices and methods for the application of one or more colours to a reflective display system, such as an electrophoretic display, wherein the colours are applied to one or more regions of the display where colour is desired.

### CROSS REFERENCE TO RELATED APPLICATION

This application claims the benefit of United States Provisional Application No. 62/694,133 filed on Jul. 5, 2018 and entitled “Reflective Display With Added Colours.”

### FIELD OF THE INVENTION

The present invention is directed generally, but not by way of limitation, to a reflective display system that incorporates multiple colours into the display.

### BACKGROUND

Reflective displays are available which can display only black and white images, such as a twisted nematic (TN) and liquid crystal displays (LCD). In LCDs, each display pixel is divided into three subpixels which include a red, green, or blue colour filter layer. By adjusting transmission/reflection through each subpixel, an array of colour combinations can be achieved. Two particle electrophoretic displays (EPD) and, alternatively, three particle EPDs exist which allow one additional colour to be displayed alongside black and white. Currently this additional colour is limited to either red or yellow, but not both. However, for displays used in a retail application, it is often necessary to be able to highlight regions of the display in additional colours such as orange, green, blue, or any other colour that might suit the particular branding requirements of the retailer.

It is possible to incorporate other colours into the EPD itself by substitution of the red or yellow particles with particles of an alternative colour. However such a change requires complex re-optimization of particle creation, particle treatment and also compatibility with the rest of the EPD system (other particles, spacer walls, and/or capping layers). Furthermore providing many different film types for different retail customers creates complex supply chain issues since each batch of EPD film must be completed into a final display within a short period of manufacture. Storage of film beyond three months is not recommended.

### SUMMARY

The present invention overcomes the problems in the prior art by utilizing EPD types and adding colours by a number of different methods. In exemplary embodiments, these added coloured layers may be added using colour printing on the surface of the display, using an Electronic ink (Eink) layer, or using a coloured foil layer. Combinations of these methods may also be used.

A preferred embodiment of the present invention comprises a multilayered electrophoretic display module comprising:
an electrophoretic display layer comprising,
   a thin-film transistor backplane layer,
   an electrophoretic display imaging layer comprising at least two colours formed of electronic ink provided on the electrophoretic display imaging layer, and
   a protective screen layer,
a colour layer comprising at least one colour and being adjacent to the electrophoretic display layer; and
a hardcoat layer adjacent to the colour layer;
wherein the backplane layer has an edge seal.

An alternative preferred embodiment of the present invention comprises a method of displaying multiple colours in a multilayered reflective display, the method comprising the steps of:
providing an electrophoretic display layer comprising,
   a thin-film transistor backplane layer,
   an electrophoretic display imaging layer comprising at least two colours formed of electronic ink provided on the electrophoretic display imaging layer, and
   a protective screen layer,
providing a colour layer comprising at least one colour and layering the colour layer in a layered position adjacent to the electrophoretic display layer; and
providing a hardcoat layer and layering the hardcoat layer in a layered position adjacent to the colour layer;
wherein the backplane layer has an edge seal.

### BRIEF DESCRIPTION OF THE DRAWINGS

FIG. 1 depicts a typical EPD module as found in the prior art.

FIG. 2 depicts a reflective display according to a preferred first embodiment of the invention.

FIG. 3 depicts an example of the reflective display according to the first embodiment of the invention.

FIG. 4 depicts an example of a reflective display according to a preferred second embodiment of the invention.

FIG. 5 depicts an example of a reflective display according to a preferred third embodiment of the invention.

### DETAILED DESCRIPTION

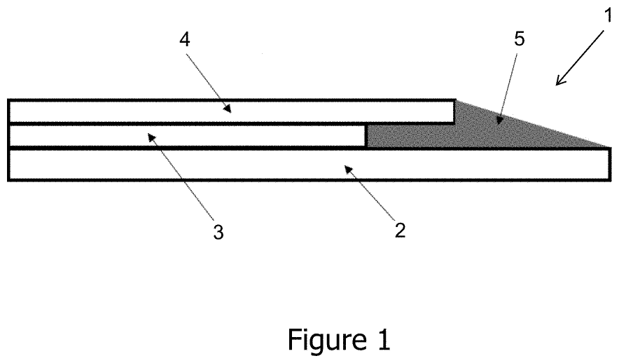

FIG. 1 shows the constituent layers of a typical EPD module. As shown in FIG. 1, an (EPD) module 1 includes a backplane 2 made of a thin-film transistor (TFT) array preferably provided on glass or similar material which allows electronic signals to be applied to display pixels of the EPD module 1. Onto this is laminated the EPD imaging layer 3. The EPD imaging layer 3 may be created in various ways, including using electronic ink (E ink) developed and commercialized by the E Ink Corporation located in Cambridge, Massachusetts. A protective screen layer 4 is preferably included over the EPD layer 3. The protective screen layer 4 carries gas blocking layers, UV blocking layers and a hardcoat top layer to avoid scratch damage. As shown in FIG. 1, an edge seal 5 is also added which hermetically seals the display 1 interior from the outside atmosphere to prevent entry or exit of moisture and air. In typical production, the order of addition is lamination of the EPD imaging layer 3 then lamination of the protective screen layer 4 and finally the application of the edge seal 5.

The applicants' novel invention allows coloured transparent coatings to be added to the top of a typical EPD module 1 as shown in FIG. 1. In a first embodiment, this invention comprises the addition of one or more additional colors by pre-treating the existing EPD top surface to allow adhesion of further coatings, the addition of a coloured layer using inkjet printing or another suitable printing method, and then the overcoating of the coloured layer with a hard protective layer if necessary. Additional components and steps may also be added.

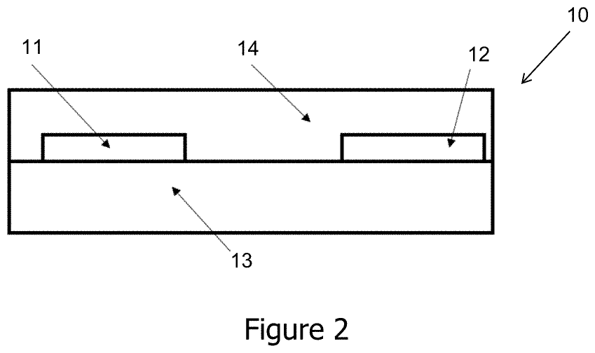

FIG. 2 shows a schematic section of a reflective display module 10 of a first embodiment of the invention, in which a first colour region 11 or both a first and a second colour region 11, 12 are added on top of an EPD display 10. It is contemplated that more than two color regions may be used. In FIG. 2, two colour regions, such as first colour region 11 and second colour region 12, are added on top of an EPD 13, such as the EPD module 1 shown in FIG. 1. A clear hardcoat 14 is preferably applied on top of the EPD 13, including over the first colour region 11 and the second colour region 12.

Pretreatment of the existing top surface of the EPD 13 prior to application of a colour region 11, 12 can be performed in a number of ways including, for example, UV ozone cleaning, plasma cleaning, chemical washing, chemical etching, and/or attachment of adhesion promoting chemicals. The coloured regions 11, 12 can be applied by a variety of methods including, for example, inkjet printing, screen printing, offset printing or any other printing method which is capable of accurately controlling the thickness and location of the coloured layer 11, 12. Following coating, the coloured layers 11, 12 are dried or cured by a suitable method such as using heat and/or UV irradiation, or by another fixing method. Finally an additional optically clear hardcoat 14 may be added on top of the coloured layer 11, 12 in order to achieve desired scratch resistance.

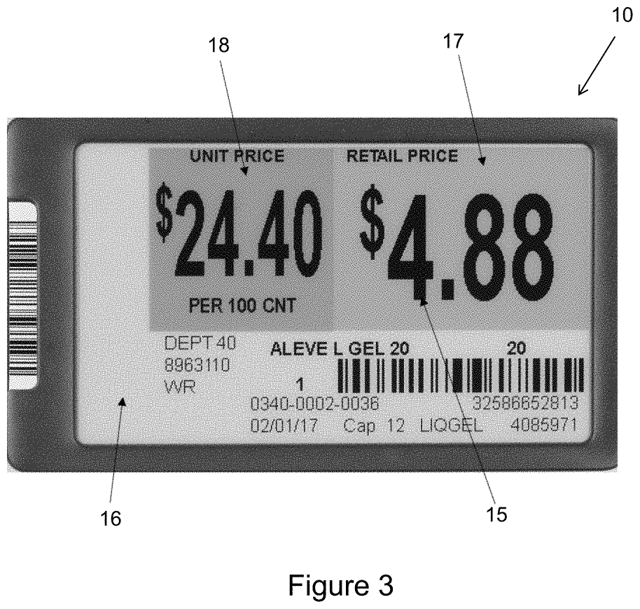

FIG. 3 shows an example of an EPD display module 10 according to the first embodiment of the invention in which three colours originate from the EPD display layer 13 (black 15, white 16, yellow 17), while one colour (orange region 18) is printed on top of the display 13. After printing of this orange region 18, an additional hardcoat material 14 may be applied across the entire front surface of the display 10 so that the surface finish of the front surface shows consistency as well as ensuring the correct level of scratch resistance. Since the orange region 18 is fixed, pixels within this region 18 can only display orange (white 16 from the EPD 1 plus the orange region 18) or black (black 15 from the EPD 1 plus the orange region 18).

It is also possible to combine one colour from the EPD 1 with another colour in a printed overlayer in order to allow the rendering of a third colour. For example, printing a blue region (not shown) on an EPD 1 and then selecting the yellow colour 17 from the underlying EPD layer 1 will lead to a resultant green colour (not shown). In another embodiment, instead of adding colour by printing an overlayer, colour may be added by incorporating a coloured foil within the EPD 1 layers during fabrication.

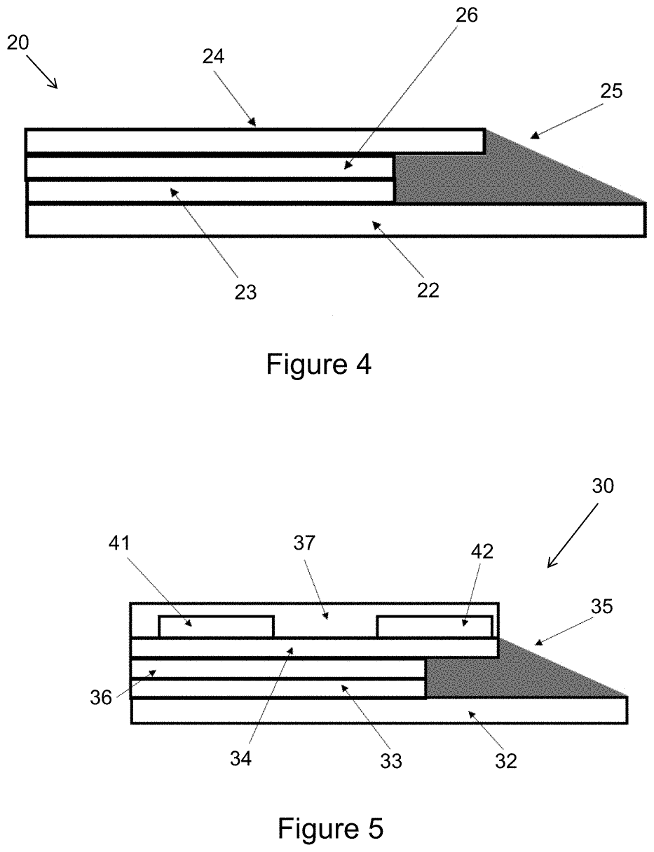

FIG. 4 shows a second embodiment of the invention, a reflective display module 20, which modifies an EPD module 1 comprising a TFT backplane 22 having an edge seal 25 and including a coloured foil layer 26 which is laminated after an Eink imaging layer 23 is applied but before a protective screen layer 24 is applied. The coloured foil 26 contains coloured layers either within its construction or added later by printing. This method of adding extra colours is carried out during the fabrication of the original EPD module 20 rather than being added afterwards, requiring the modules 20 to be customised at an earlier stage. This method takes advantage of the scratch resistance of the existing protective screen layer 24 and therefore does not require further layers in order to achieve scratch resistance.

It is also possible to combine colour foil and printed colour approaches so that additional custom colours can be added to a standard EPD unit 1. This embodiment of a reflective display module 30 is shown in FIG. 5. As shown in FIG. 5, a TFT backplane 32 having an edge seal 35 is covered by an Eink EPD layer 33 including one or more colours, which is in turn covered by a coloured foil layer 36, which is covered by a protective screen layer 34. Over the protective screen layer 34 is applied two additional colored regions 41, 42 (as in FIG. 2) to provide further colours. Only one of regions 41, 42 may be applied, or, alternatively, more than two regions may be applied. A clear hardcoat 37 is then applied on top of the other layers.

Pixel-level colour filters, such as those of the prior art, have several drawbacks. For example, they comprise a set of subpixels (usually red, green, and blue) applied to all pixels within a display. In other words, the primary colours are fixed across the entire display, such as that of an LCD. Colour filters cannot be efficiently combined with an underlying coloured EPD region. Such displays also cannot reflect a white state with a high efficiency. High resolution patterning of the colour filter in such displays is expensive and requires thin substrates along with the critical alignment with the underlying EPD in order to avoid parallax and/or colour errors.

By contrast, area-level colour filters, such as those described herein and in accordance with preferred embodiments of the present invention, are applied only to one or more regions of a display where colour is desired. The remainder of the display may show, for example, a high reflectivity white. The coloured regions can be designed to combine with an underlying white state in the EPD, and also with an underlying yellow or red state. Combining one colour in the filter with another colour in the EPD allows a third colour to be efficiently generated. Low resolution patterning of the colour filter region avoids parallax problems and allows patterning to be applied by simple printing to the outside of the display. Thus, preferred commercial embodiments of the present invention define a device construction which can provide better performance while being more straightforward in manufacture.

Therefore this invention comprises several ways to add an additional colour or multiple colours to an EPD module so that it can be customised for the needs of a user, such as a retailer. Although the present invention has been illustrated and described with reference to various embodiments and specific examples, those embodiments and examples are only exemplary, and it will be readily apparent to those of ordinary skill in the art that other embodiments and examples may perform similar functions or achieve like results. Consequently, the disclosed embodiments and examples are not to be considered limitations on the disclosure or the invention.

1. A multilayered electrophoretic display module comprising:
an electrophoretic display layer comprising,
a thin-film transistor backplane layer,
an electrophoretic display imaging layer comprising at least two colours formed of electronic ink provided on the electrophoretic display imaging layer, and
a protective screen layer,
a colour layer comprising at least one colour and being adjacent to the electrophoretic display layer; and
a hardcoat layer adjacent to the colour layer;
wherein the backplane has an edge seal.

2. The multilayered electrophoretic display module of claim 1, the electrophoretic display imaging layer further comprising at least three colours.

3. The multilayered electrophoretic display module of claim 2, the colour layer further comprising at least two colours.

4. The multilayered electrophoretic display module of claim 1, the colour layer further comprising at least two colours.

5. The multilayered electrophoretic display module of claim 1, wherein the at least one colour comprising the colour layer is printed onto a region of the electrophoretic display layer.

6. The multilayered electrophoretic display module of claim 1, wherein the colour layer further comprises first and second colours, wherein the first colour is printed onto a first region of the electrophoretic display layer, wherein the second colour is printed onto a second region of the electrophoretic display layer, and wherein the first and second regions do not overlap.

7. The multilayered electrophoretic display module of claim 6, wherein one of the two colours comprising the electrophoretic display imaging layer is the exclusive colour comprising a third region of the electrophoretic display layer, and wherein the first, second, and third regions do not overlap.

8. The multilayered electrophoretic display module of claim 7, wherein the colour comprising the third region is the colour white.

9. The multilayered electrophoretic display module of claim 1, the electrophoretic display layer further comprising a coloured foil layer adjacent to the electrophoretic display imaging layer and adjacent to the protective screen layer.

10. The multilayered electrophoretic display module of claim 9, the coloured foil layer further comprising at least two colour layers.

11. The multilayered electrophoretic display module of claim 10, the electrophoretic display imaging layer further comprising at least three colours.

12. A method of displaying multiple colours in a multilayered reflective display, the method comprising the steps of:
providing an electrophoretic display layer comprising,
a thin-film transistor backplane layer,
an electrophoretic display imaging layer comprising at least two colours formed of electronic ink provided on the electrophoretic display imaging layer, and
a protective screen layer,
providing a colour layer comprising at least one colour and layering the colour layer in a layered position adjacent to the electrophoretic display layer; and
providing a hardcoat layer and layering the hardcoat layer in a layered position adjacent to the colour layer;
wherein the backplane layer has an edge seal.

13. The method of displaying multiple colours in a multilayered reflective display of claim 12,
wherein the colour layer further comprises first and second colours, and the method further comprising the steps of:
printing the first colour onto a first region of the electrophoretic display layer; and
printing the second colour onto a second region of the electrophoretic display layer;
wherein the first and second regions do not overlap.

14. The method of displaying multiple colours in a multilayered reflective display of claim 12, the method further comprising the step of:
providing a coloured foil layer and layering the coloured foil layer adjacent to both the electrophoretic display imaging layer and the protective screen layer.
